(19) United States
(12) Patent Application Publication
(10) Pub. No.: US 2005/0264197 A1
(43) Pub. Date: Dec. 1, 2005

(54) Plasma display panel

(75) Inventors: Masaki Yoshinari, Yamanashi-ken (JP); Takashi Yamada, Yamanashi-ken (JP); Yoichi Okumura, Yamanashi-ken (JP); Tasuku Ishibashi, Yamanashi-ken (JP)

Correspondence Address: ARENT FOX PLLC, 1050 CONNECTICUT AVENUE, N.W., SUITE 400, WASHINGTON, DC, 20036, US

(73) Assignee: Pioneer Corporation

(21) Appl. No.: 11/130,172

(22) Filed: May 17, 2005

(30) Foreign Application Priority Data
May 26, 2004 (JP) JP2004-156018

(51) Int. Cl. H01J 17/49

(52) U.S. Cl. 313/582

(57) ABSTRACT

A front and back glass substrates are placed on either side of a discharge spaces. A plurality of sustain electrode pairs extend in a row direction and are regularly arranged in a column direction on the front glass substrate. A dielectric layer covering the sustain electrode pairs is formed on the front glass substrate. A plurality of address electrodes initiating a discharge in conjunction with the sustain electrodes in each discharge cell formed in the discharge space extend in the column direction and are regularly arranged in the row direction. A first metallic partition wall unit defining the discharge cells is formed on the front glass substrate. A second metallic partition wall unit defining the discharge cells adjoined to the first partition wall unit is formed on the back glass substrate.

### BACKGROUND OF THE INVENTION

1. Field of the Invention

This invention relates to a panel structure of surface-discharge-type alternating-current plasma display panels.

The present application claims priority from Japanese Application No. 2004-156018, the disclosure of which is incorporated herein by reference.

2. Description of the Related Art

FIGS. 1 to 3 illustrate the structure of a conventional surface-discharge-type alternating-current plasma display panel (hereinafter referred to as “PDP”). FIG. 1 is a front view of the conventional PDP. FIG. 2 is a sectional view taken along the V-V line in FIG. 1 and FIG. 3 is a sectional view taken along the W-W line in FIG. 1.

In FIGS. 1 to 3, a plurality of sustain electrode pairs (X, Y) is provided on a rear-facing face (i.e. the face facing toward the rear of the PDP) of a front glass substrate 1 forming the display face of the PDP. The sustain electrode pairs (X, Y) extend in the row direction (the right-left direction in FIG. 1) of the front glass substrate 1 and are arranged in parallel.

The sustain electrode X(Y) is composed of T-shaped transparent electrodes Xa (Ya) formed of a transparent conductive film made of ITO or the like, and a bus electrode Xb (Yb) formed of a metal film. The bus electrode Xb (Yb) extends in the row direction of the front glass substrate 1. The narrow proximal end (corresponding to the foot of the “T”) of each transparent electrode Xa (Ya) is connected to the bus electrode Xb (Yb).

The sustain electrodes X and Y are arranged in alternate positions in the column direction of the front glass substrate 1 (the vertical direction in FIG. 1). In each sustain electrode pair (X, Y), the transparent electrodes Xa and Ya are regularly spaced along the associated bus electrodes Xb and Yb and each extend out toward its counterpart in the sustain electrode pair, so that the wide distal ends (corresponding to the head of the “T”) of the transparent electrodes Xa and Ya face each other with a discharge gap g having a required width in between.

A dielectric layer 2 is formed on the rear-facing face of the front glass substrate 1 so as to cover the sustain electrodes X, Y, and has additional dielectric layers 3 projecting therefrom toward the rear of the PDP. Each of the additional dielectric layers 3 extends in parallel to back-to-back bus electrodes Xb and Yb of the adjacent sustain electrode pairs (X, Y) in a position corresponding to the bus electrodes Xb and Yb and to the area between the bus electrodes Xb and Yb.

On the rear-facing faces of the dielectric layer 2 and the additional dielectric layers 3, an MgO protective layer 4 is formed.

The front glass substrate 1 is parallel to a back glass substrate 5 on both sides of a discharge space S. Address electrodes D are arranged in parallel at predetermined intervals on the front-facing face (i.e. the face facing toward the front of the PDP) of the back glass substrate S. Each of the address electrodes D extends in a direction at right angles to the sustain electrode pair (X, Y) (i.e. the column direction) in a position confronting the paired transparent electrodes Xa and Ya of the sustain electrode pairs (X, Y).

On the front-facing face of the back glass substrate 5, a white column-electrode protective layer (dielectric layer) 6 covers the address electrodes D and in turn a partition wall unit 7 is formed on the column-electrode protective layer 6.

The partition wall unit 7 is formed of glass materials by a sandblasting technique, and shaped in substantial grid form of vertical walls 7A and transverse walls 7B. Each of the vertical walls 7A extends in the column direction between adjacent address electrodes D. Each of the transverse walls 7B extends in the row direction in a plane following the strip area including back-to-back bus electrodes Xb and Yb of the adjacent sustain electrode pairs (X, Y) and the area between the bus electrodes Xb and Yb.

The grid-shaped partition wall unit 7 partitions the discharge space S between the front glass substrate 1 and the back glass substrate 6 into quadrangles to form discharge cells C in positions each corresponding to the paired transparent electrodes Xa and Ya of each sustain electrode pair (X, Y).

The transverse wall 7B of the partition wall 7 is in contact with the additional dielectric layer 3 to block off adjacent discharge cells C from each other in the row direction.

In each discharge cell C, a phosphor layer 8 covers five faces: the side faces of the vertical walls 7A and the transverse walls 7B of the partition wall unit 7 and the face of the column-electrode protective layer 6. The three primary colors, red, green and blue, are individually applied to the phosphor layers 8 such that the red, green and blue colors in the discharge cells C are arranged in order in the row direction.

The discharge space S between the front glass substrate 1 and the back glass substrate 5 is filled with a discharge gas including xenon.

A conventional PDP of such a structure is disclosed in Japanese Patent Laid-open publication 2000-195431, for example.

In this PDP, a reset discharge is produced between the sustain electrodes X and Y or between the sustain electrode Y and the address electrode D. Then, an address discharge is produced selectively between the transparent electrode Ya of the sustain electrode Y and the address electrode D, resulting in the deposition of wall charge on the dielectric layer 2 facing the discharge cell C in which the address discharge has been produced.

Under these conditions, a sustain pulse is applied alternately to the sustain electrodes X and Y in each sustain electrode pair (X, Y), to initiate a sustain discharge in the discharge cell (light-emitting cell) having the deposition of wall charge on the dielectric layer 2.

By means of the sustain discharge, vacuum ultraviolet light is emitted from the xenon in the discharge gas filling the light-emitting cell, and excites the red-, green- and blue-colored phosphor layers 8. Thereupon, the phosphor layers 8 emit visible light, thus generating an image on matrix display.

The light-emitting efficiency of the PDP structured as described above is related to the volume of the space inside the discharge cell C. The greater the space in the discharge cell C, the larger the surface area of the phosphor layer 8 and the greater the improvement in the light-emitting efficiency.

In this connection, with the recent advances in high definition in a PDP, the need arises to increase the height of the discharge cell C (i.e. the width in the thickness direction of the panel) in order to improve the light-emitting efficiency because the width dimension of the discharge cell C is limited and an increase in the width dimension thereof is impossible.

The height of the discharge cell C is defined by the height of the partition wall unit 7 and the height of the additional dielectric layer 3 which is connected via the protective layer 4 to the transverse wall 7B of the partition wall unit 7 (see FIG. 2).

However, because the partition wall unit 7 of the conventional PDP is formed by using glass materials and sandblasting techniques, the partition wall unit 7 may possibly produce a defect, an inclination and/or the like. This limits the maximum height of the partition wall unit 7.

Further, the additional dielectric layer 3 is formed by the use of a method such as printing dielectric materials or applying a film. This limits the maximum height of the additional dielectric layer 3.

These facts make it impossible in the conventional PDPs to increase the height of the discharge cell C beyond predetermined limits. When the dimension of the discharge cell C in the width direction is decreased for the sake of the higher definition of the PDP, the problem arises of a reduction in the light-emitting efficiency in the discharge space in the discharge cell C.

### SUMMARY OF THE INVENTION

An object of the present invention is to solve the problems associated with the surface-discharge-type alternating-current PDPs as described above.

To attain this object, a PDP according to the present invention has a pair of opposing first and second substrates with a discharge space in between, a plurality of row electrode pairs extending in the row direction and regularly arranged in the column direction on the first substrate, a dielectric layer formed on the first substrate and covering the row electrode pairs, and a plurality of column electrodes extending in the column direction, regularly arranged in the row direction and producing a discharge in conjunction with the row electrodes in each unit light-emitting area formed in the discharge space. The PDP further has a first partition wall unit provided on the first substrate for defining the unit light-emitting areas and a second partition wall unit provided on the second substrate for defining the unit light-emitting areas and positioned opposite the first partition wall unit. The first partition wall unit and the second partition wall unit each have a metal-made base formed in a required shape and an insulation film covering the surface of the base.

An embodiment of the present invention can be described by citing a PDP having a first partition wall unit and a second partition wall unit partitioning the discharge space between a front glass substrate and a second glass substrate into discharge cells. The first partition wall unit has an insulation film formed of a secondary electron emission material (high γ material), such as MgO, and covering the surface of a metallic base. The first partition wall unit is formed on the face of the front glass substrate facing the back glass substrate. The second partition wall unit has an insulation film covering the surface of a metallic base and is formed on the face of the back glass substrate facing the front glass substrate so as to be in contact with the first partition wall unit.

In the PDP according to the embodiment, the height (the width in the thickness direction of the panel) of the discharge cell is determined by the height of the first partition wall unit formed on the front glass substrate and the height of the second partition wall unit formed on the back glass substrate. Further, the first and second partition wall units are made of metal. Hence, as compared with the partition wall unit of a conventional PDP which is formed using glass materials and sandblasting technique, it is possible to form a partition wall unit at a desired height without the possibility of the occurrence of a defect, an inclination and/or the like in the partition wall unit.

Further, instead of an additional dielectric layer formed of dielectric materials, the PDP in this embodiment has the metallic first partition wall unit formed in a position corresponding to the position of the additional dielectric layer formed in the conventional PDP. This makes it possible to make the height of the discharge cell higher than that of the conventional PDP.

Still further, the first partition wall unit has the function of preventing the spread of a surface discharge initiated between the sustain electrodes outward from the interior of the discharge cell, similar to that of the additional dielectric layer of the conventional PDP.

In consequence, the PDP of the embodiment is enabled to make the height of the discharge cell higher than that of the conventional PDP, thereby improving the light emitting efficiency even when the definition of the PDP is heightened These and other objects and features of the present invention will become more apparent from the following detailed description with reference to the accompanying drawings.

### BRIEF DESCRIPTION OF THE DRAWINGS

FIG. 1 is a front view illustrating an example of the related art.

FIG. 2 is a sectional view taken along the V-V line in FIG. 1.

FIG. 3 is a sectional view taken along the W-W line in FIG. 1.

FIG. 4 is a schematic front view illustrating a first embodiment according to the present invention.

FIG. 5 is a sectional view taken along the V-V line in FIG. 4.

FIG. 6 is a flowchart illustrating the manufacturing process for a plasma display panel according to the first embodiment.

FIG. 7 is a schematic front view illustrating a second embodiment according to the present invention.

FIG. 8A is a sectional view taken along the VIII-VIII line in FIG. 7.

FIG. 8B is a sectional view illustrating another example of the second embodiment.

FIG. 9 is a flowchart illustrating the manufacturing process for a plasma display panel according to the second embodiment.

FIG. 10 is a sectional view illustrating a modified example of the second embodiment.

### DETAILED DESCRIPTION OF THE PREFERRED EMBODIMENTS

First Embodiment

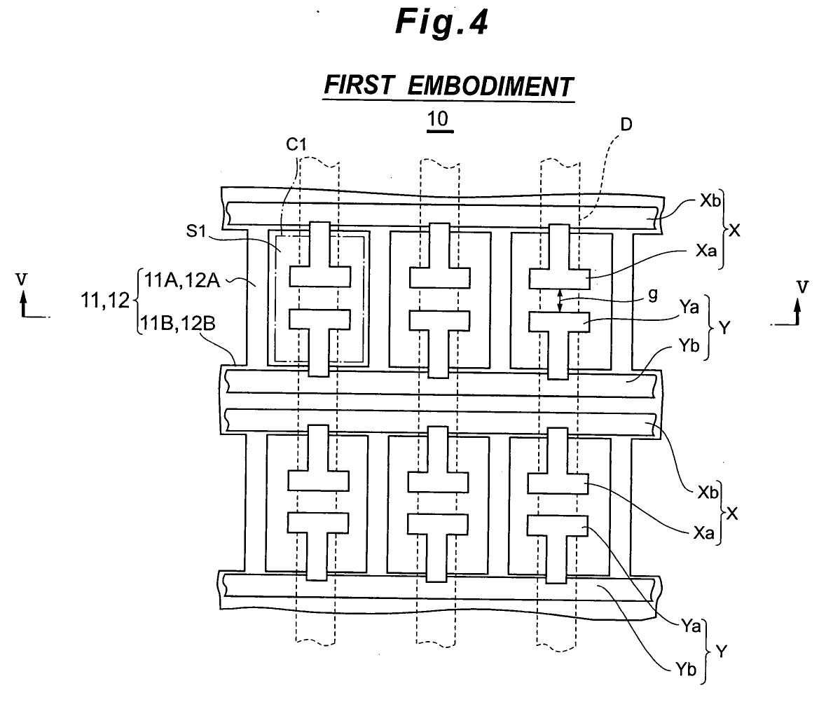

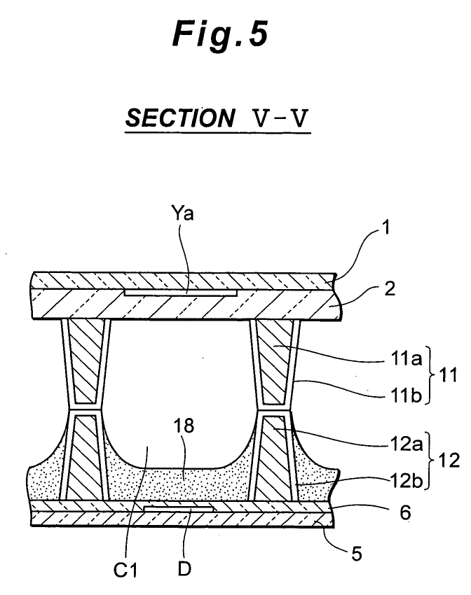

FIGS. 4 to 5 illustrate a first embodiment of a PDP according to the present invention. FIG. 4 is a schematic front view of the PDP in the first embodiment. FIG. 5 is a sectional view taken along the VI-VI line in FIG. 4.

In FIGS. 4 and 5, the PDP 10 has a plurality of sustain electrode pairs (X, Y) extending in the row direction (the right-left direction in FIG. 4) and regularly arranged in the column direction (the vertical direction in FIG. 4) on the rear-facing face of a front glass substrate 1 which serves as the display surface of the PDP.

Each of sustain electrodes X and Y constituting a sustain electrode pair (X, Y) is composed of a bus electrodes Xb (Yb) extending in a bar shape in the row direction, and transparent electrodes Xa (Ya) which are spaced at regular intervals along the bus electrode Xb (Yb) and each extends from the bus electrode Xb (Yb) toward its counterpart in the sustain electrode pair, so that the transparent electrodes Xa and Ya face each other across a discharge gap g.

A dielectric layer 2 is formed on the rear-facing face of the front glass substrate 1 so as to cover the sustain electrode pairs (X, Y).

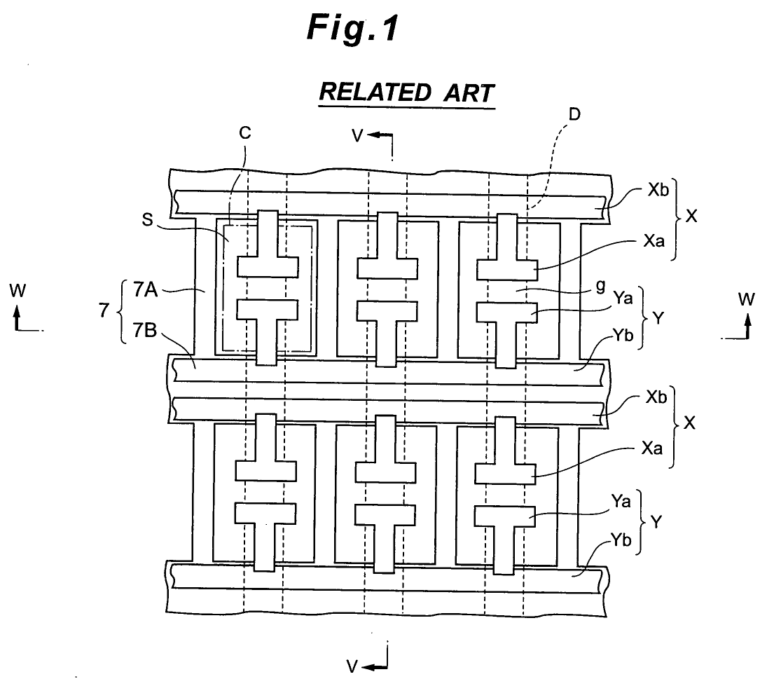

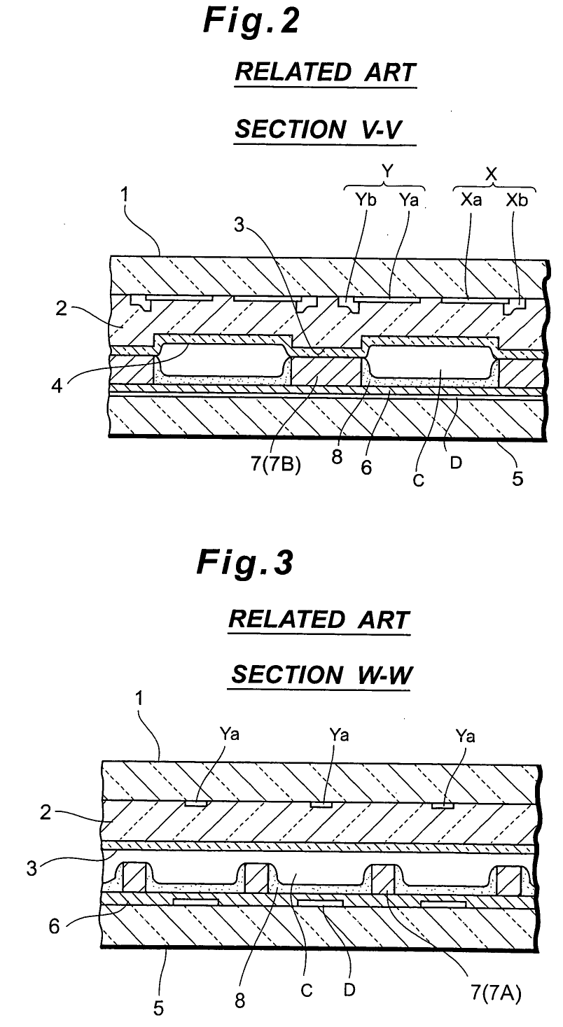

The above structure is the same as the structure of the conventional PDP illustrated in FIGS. 1 to 3. The same components are designated by the same reference numerals.

A first partition wall unit 11 made of metal is formed on a protective layer.

The first partition wall unit 11 is composed of a metallic base 11a and an insulation film 11b covering the surface of the base 11a.

The first partition wall unit 11 is formed in a substantial grid shape made up of first vertical walls 11A and first transverse walls 11B. Each of the first vertical walls 11A extends in the column direction in a plane following the line of the positions between adjacent transparent electrodes Xa (Ya) arranged along the bus electrodes Xb (Yb) of the sustain electrodes X (Y). Each of the first transverse walls 11B extends in the row direction opposite to back-to-back bus electrodes Xb and Yb of the adjacent sustain electrode pairs (X, Y) and the area between the bus electrodes Xb and Yb.

The insulation film 11b partially constituting the first partition wall unit 11 is formed of a high γ insulation film such as MgO, or alternatively an insulation film such as Al₂Si₃, or Si₂O₃. The protective layer (not shown) formed of a high γ dielectric material such as MgO is formed on the rear-facing face of the dielectric layer 2 and covers the surface of the dielectric layer 2.

The front glass substrate 1 is placed opposite a back glass substrate 5 with a discharge space S1 in between. Address electrodes D are arranged in parallel at predetermined intervals on the front-facing face of the back glass substrate 5. Each of the address electrodes D extends in a direction at right angles to the sustain electrode pair (X, Y) (i.e. the column direction) in a position opposite to the paired transparent electrodes Xa and Ya of each sustain electrode pair (X, Y).

On the front-facing face of the back glass substrate 5, a white column-electrode protective layer (dielectric layer) 6 covers the address electrodes D.

The structure of the back glass substrate 5 as described above is the same as that in the conventional PDP described in FIGS. 1 to 3. The same components are designated by the same reference numerals.

A second partition wall unit 12 is formed on the column-electrode protectively layer 6.

As in the case of the aforementioned first partition wall unit 11, the second partition wall unit 12 is composed of a metallic base 12a and an insulation film 12b covering the surface of the base 12a.

The second partition wall unit 12 is formed in a substantial grid shape of second vertical walls 12A and second transverse walls 12B. Each of the second vertical walls 12A extends in the column direction in a position opposite the first vertical wall 11A of the first partition wall unit 11 (i.e. in a plane following the line of the positions between adjacent address electrodes D regularly arranged in the row direction). Each of the second transverse walls 12B extends in the row direction in a position opposite to the first transverse wall 11B of the first partition wall unit 11 (i.e. in a position corresponding to the area including back-to-back bus electrodes Xb and Yb of the adjacent sustain electrode pairs (X, Y) and the area between the bus electrodes Xb and Yb on the front glass substrate 1).

The insulation film 12b partially constituting the second partition wall unit 12 is formed of an insulation film such as Al₂Si₃, or Si₂O₃.

The top faces of the second vertical walls 12A and the second transverse walls 12B of the second partition wall unit 12 are parallel to the front glass substrate 1. The top faces of the first vertical walls 11A and the first transverse walls 11B of the first partition wall unit 11 are parallel to the back glass substrate 5. The top faces of the second partition wall unit 12 are in contact with the respective top faces of the first partition wall unit 11.

A phosphor layer 18 is formed on five faces: the face of each portion of the column-electrode protective layer 6 defined by the second partition wall unit 12 and the side faces of the two second vertical walls 12 A and the two second transverse walls 12B of the second partition wall unit 12. The red-, green- and blue-colored phosphor layers 18 are arranged in order in the row direction.

The first partition wall unit 11 thus formed on the front glass substrate 1 and the second partition wall unit 12 thus formed on the back glass substrate 5 partition the discharge space S1 between the front glass substrate 1 and the back glass substrate 5 into areas each corresponding to the opposing paired transparent electrodes Xa and Ya in each sustain electrode pair (X, Y), to form discharge cells C1.

The discharge space S1 between the front and back glass substrates 1 and 5 is filled with a discharge gas including xenon.

In the above-mentioned PDP 10, as in the case of conventional PDPs, are set discharge is produced between the sustain electrodes X and Y in the sustain electrode pairs (X, Y) or between the sustain electrode Y and the address electrode D. Then, an address discharge is produced between the sustain electrode Y and the address electrode D. Following that, a sustain discharge is produced across the discharge gap formed between the opposing transparent electrodes Xa and Ya of the sustain electrodes X and Y constituting the sustain electrode pair (X, Y). Thereby, an image is generated on matrix display.

In the PDP 10, the height (the width in the thickness direction of the PDP 10) of the discharge cell C1 is decided by the heights of the first partition wall unit 11 formed on the front glass substrate 1 and the second partition wall unit 12 formed on the back glass substrate 5 which are in contact with each other at their top faces.

The first partition wall unit 11 and the second partition wall unit 12 of the PDP have the bases 11a and 12a formed of metal materials. Hence, as compared with the partition wall of a conventional PDP which is formed using glass materials and sandblasting technique, there is no possibility of a defect, an inclination and/or the like occurring in the partition wall units, and therefore the partition wall unit is capable of being formed to a required height.

Instead of an additional dielectric layer formed of dielectric materials, the PDP 10 of the first embodiment has the metallic first partition wall unit 11 formed in the position corresponding to the additional dielectric layer formed in the conventional PDP. This makes it possible to design the greater height of the discharge cell C1 as compared with that of the conventional PDP.

Further, the first partition wall unit 11 has the function of preventing the spread of a surface discharge initiated between the sustain electrodes outward from the interior of the discharge cell C1, similar to that of the additional dielectric layer of the conventional PDP.

Thus, the PDP 10 is enabled to have the discharge cell C1 of a greater height than that of the conventional PDP. In turn, this makes it possible to improve the light-emitting efficiency even when the PDP is designed to have a higher definition.

Further, since the first partition wall unit 11 is formed on the front glass substrate 1, an increase in the height of the first partition wall unit 11 means an increase in the area of the insulation film 11b which partially forms the first partition wall unit 11 and is made of the secondary electron emission material (high γ material) such as MgO. Therefore, the insulation layer 11b contributes to an improvement in the secondary electron emission characteristics in the discharge cell C1 as compared with the case of the conventional PDP. This improvement increases the discharge efficiency, resulting also in an increase in the light-emitting efficiency.

Further, if the height of the second partition wall unit 12 on the back glass substrate 5 is set high, the layer thickness and the surface area of the phosphor layer 18 formed on the inner surface of the second partition wall unit 12 can be increased, resulting also in an increase in the light-emitting efficiency.

In the PDP 10, the MgO layer (insulation film 11b) is formed only on the front glass substrate 1 and the phosphor layer 18 is formed only on the back glass substrate 5. For these reasons, the manufacturing steps for the front glass substrate 1 and the manufacturing steps for the back glass substrate 5 are performed independently, thus facilitating the entire manufacturing process.

The PDP 10 has the metallic first partition wall unit 11 formed on the front glass substrate 1 instead of the conventional additional dielectric layer. This design eliminates the need of the complicated steps for forming the additional dielectric layer. Further, because the previously formed first partition wall unit 11 is mounted on the rear-facing face of the dielectric layer 2, the manufacturing process is simplified.

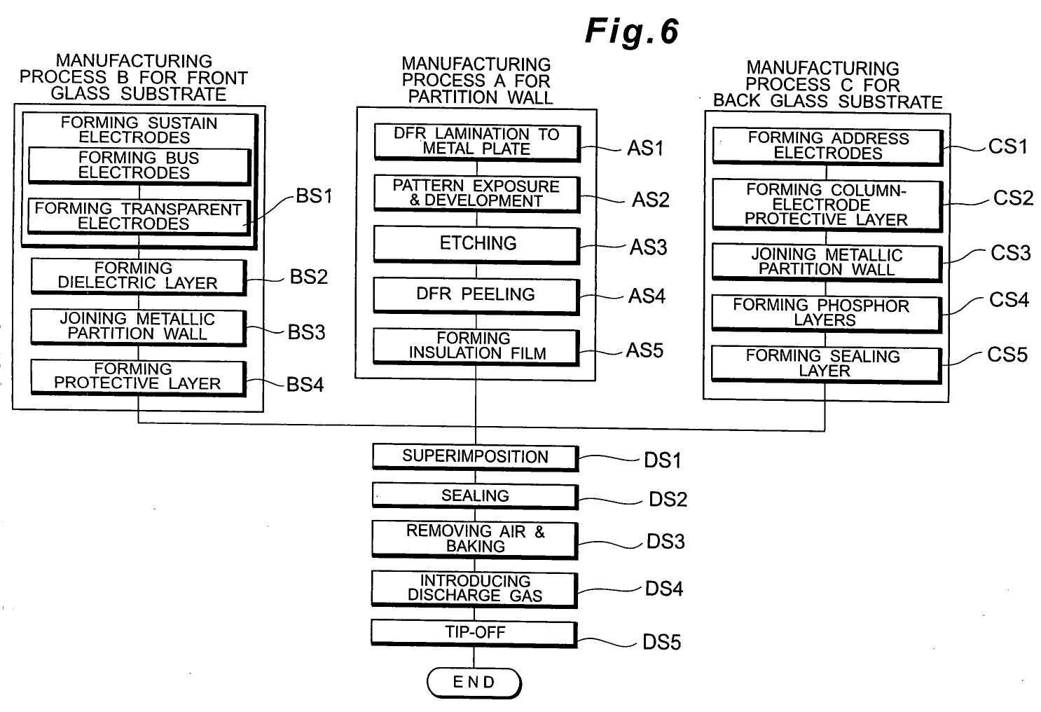

FIG. 6 shows a flowchart of the manufacturing process of the PDP 10.

Next, the manufacturing process for the PDP 10 will be described with reference to FIG. 6.

In the manufacturing process A for the metallic partition wall, the step of performing DFR lamination on a metal plate (step AS1) is performed, and then the step of pattern exposure and development (step AS2) is performed.

After step AS2, the step of etching (step AS3) is performed to form the metal plate into a substantial grid-shaped first partition wall unit 11 or a substantial grid-shaped second partition wall unit 12. Then, the step of performing DFR peeling (step AS4) is performed.

After step AS4, by a technique such as spattering, evaporation or CVD, an insulation film 11b or 12b is formed on the surface of the metal plate which has been formed into the substantial grid shape in step AS4 (step AS5).

In the manufacturing process B for the front glass substrate 1, sustain electrodes X and Y are first formed on the rear-facing face of the front glass substrate 1 (step BS1).

Step BS1 includes the step of forming the transparent electrodes Xa and Ya of the sustain electrodes X and Y and the step of forming the bus electrodes Xb and Yb thereof.

After the sustain electrode pairs (X, Y) have been formed in step BS1, a dielectric layer 2 is formed on the rear-facing face of the front glass substrate 1 (step BS2), so as to cover the sustain electrode pairs (X, Y) which have been formed in step BS1.

In step BS2, before the burning of the dielectric layer 2, the first partition wall unit 11 fabricated in the manufacturing process A is precisely positioned on the dielectric layer 2. By burning the dielectric layer 2, the first partition wall unit 11 is joined on to the dielectric layer 2 in a predetermined position (step BS3).

After step BS3, a protective layer is formed on the rear-facing face of the dielectric layer 2 (step BS4).

In the manufacturing process C for the back glass substrate 5, address electrodes D are first formed in a predetermined position on the front-facing face of the back glass substrate 5 (step CS1). After step CS1, a column-electrode protective layer 6 is formed (step CS2).

In step CS2, before the burning of the column-electrode protective layer 6, the second partition wall unit 12 fabricated in the manufacturing process A is precisely positioned on the column-electrode protective layer 6. By burning the column-electrode protective layer 6, the second partition wall unit 12 is joined onto the column-electrode protective layer 6 in a predetermined position (step CS3).

Then, after the completion of step CS3, red, green and blue phosphor layers 18 are each formed in each of the areas defined by the grid-shaped second partition wall unit 12 (step CS4). Then, a sealing layer is formed on the periphery edge portion of the front-facing face of the back glass substrate 5 (step CS5).

The front glass substrate 1 with the various structures thus formed thereon in the manufacturing process B and the back glass substrate 5 with the various structures thus formed thereon in the manufacturing process C are placed on each other with precise alignment so as to form a discharge space between them (step DS1). Then, the step of sealing the discharge space between the front glass substrate 1 and the back glass substrate 5 (step DS2), the step of baking after removing the gases from the discharge space (step DS3), the step of introducing a discharge gas into the discharge space (step DS4), and the step of sealing the discharge gas inside (tip-off) (step DS5) are performed in order to fabricate a PDP10.

Second Embodiment

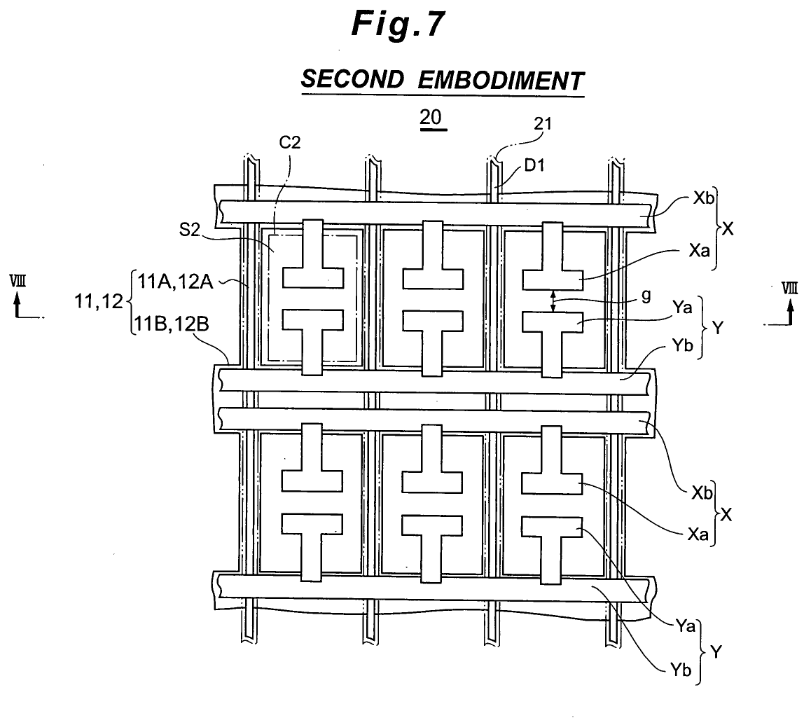

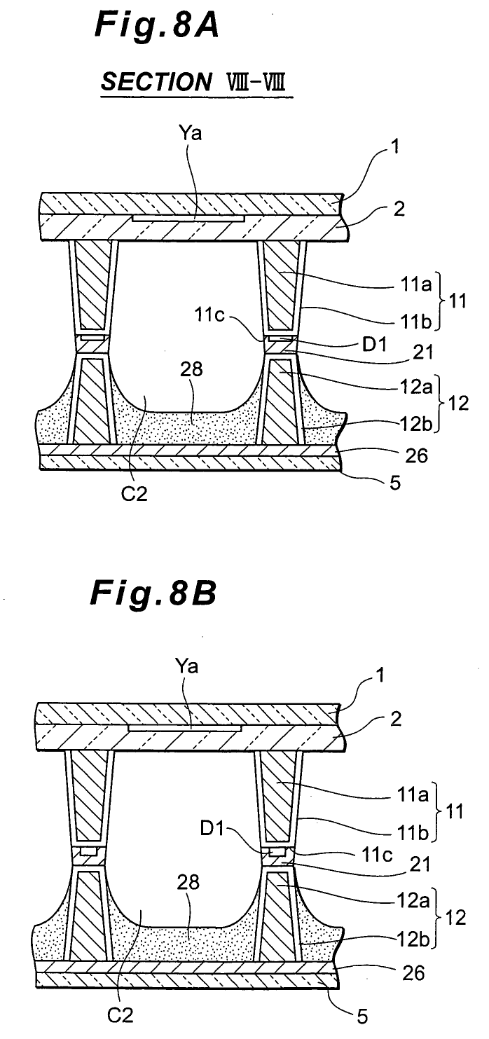

FIGS. 7, 8A and 8B illustrate a second embodiment of a PDP according to the present invention. FIG. 7 is a schematic front view of the PDP in the second embodiment. FIG. 8A is a sectional view taken along the VIII-VIII line in FIG. 7.

In FIGS. 7, 8A and 8B, the PDP 20 has a plurality of sustain electrode pairs (X, Y) extending in the row direction (the right-left direction in FIG. 7) and regularly arranged in the column direction (the vertical direction in FIG. 7) on the rear-facing face of a front glass substrate 1 which serves as the display surface of the PDP.

Each of sustain electrodes X and Y constituting a sustain electrode pair (X, Y) is composed of a bus electrode Xb (Yb) extending in a bar shape in the row direction, and transparent electrodes Xa (Ya) which are spaced at regular intervals along the bus electrode Xb (Yb) and each extends from the bus electrodes Xb (Yb) toward its counterpart in the sustain electrode pair, so that the transparent electrodes Xa and Ya face each other with a discharge gap g in between.

A dielectric layer 2 is formed on the rear-facing face of the front glass substrate 1 so as to cover the sustain electrode pairs (X, Y).

A first partition wall unit 11 made of metal is formed on a protective layer.

The first partition wall unit 11 is composed of a metallic base 11a and an insulation film 11b covering the surface of the base 11a.

The first partition wall unit 11 is formed in a substantial grid shape made up of first vertical walls 11A and first transverse walls 11B. Each of the first vertical walls 11A extends in the column direction in a plane following the line of the positions between adjacent transparent electrodes Xa (Ya) arranged along the bus electrodes Xb (Yb) of the sustain electrodes X (Y). Each of the first transverse walls 11B extends in the row direction opposite to back-to-back bus electrodes Xb and Yb of the adjacent sustain electrode pairs (X, Y) and the area between the bus electrodes Xb and Yb.

The insulation film 11b partially constituting the first partition wall unit 11 is formed of a high γ insulation film such as MgO, or alternatively an insulation film such as Al₂Si₃ or Si₂O₃.

The protective layer (not shown) formed of a high γ dielectric material such as MgO is formed on the rear-facing face of the dielectric layer 2 and covers the surface of the dielectric layer 2.

The above-mentioned structure is the same as that of the PDP 10 of the first embodiment. The same components are designated by the same reference numerals.

The top face 11c of the first partition wall unit 11 is parallel to the front glass substrate 1 and faces toward the rear of the PDP 20. Address electrodes D1 are formed on the top face 11c and each extends along the first vertical wall 11A of the first partition wall unit 11 in the column direction. Further, a dielectric cover layer 21 is formed on the top face 11c of the first partition wall unit 11 so as to cover the address electrodes D1.

As shown in FIG. 8A, the position of forming of each of the address electrodes D1 can be the central longitudinal position of the top face 11c of the first partition wall unit 11, i.e. opposite the central area between adjacent transparent electrodes Xa (Ya) regularly spaced in the row direction. However, as shown in FIG. 8B, each of the address electrodes D1 is preferably formed in a position of the top face 11c of the first partition wall unit 11 not central but closer to a transparent electrode Ya paired with the address electrode D1 as described later, in order to reliably initiate an address discharge between the address electrode D1 and the transparent electrode Ya paired therewith and to prevent the occurrence of a false discharge between the address electrode D1 and another adjacent transparent electrode Ya.

The front glass substrate 1 is placed opposite a back glass substrate 5 on either side of a discharge space S2. On the front-facing face of the back glass substrate 5, a white dielectric layer 26 is formed.

A second partition wall unit 12 is formed on the white dielectric layer 26.

As in the case of the aforementioned first partition wall unit 11, the second partition wall unit 12 is composed of a metallic base 12a and an insulation film 12b covering the surface of the base 12a.

The second partition wall unit 12 is formed in a substantial grid shape of second vertical walls 12A and second transverse walls 12B. Each of the second vertical walls 12A extends in the column direction opposite the first vertical wall 11A of the first partition wall unit 11. Each of the second transverse walls 12B extends in the row direction opposite to the first transverse wall 11B of the first partition wall unit 11.

The insulation film 12b partially constituting the second partition wall unit 12 is formed of an insulation film such as Al₂Si₃ or Si₂O₃.

The top faces of the second vertical walls 12A and the second transverse walls 12B of the second partition wall unit 12 are parallel to the front glass substrate 1, and in contact with the dielectric cover layer 21 formed on the first partition wall unit 11.

A phosphor layer 28 is formed on five faces: the face of each portion of the white dielectric layer 26 defined by the second partition wall unit 12 and the side faces of the two second vertical walls 12 A and the two second transverse walls 12B of the second partition wall unit 12. The red-, green- and blue-colored phosphor layers 8 are arranged in order in the row direction.

The first partition wall unit 11 thus formed on the front glass substrate 1 and the second partition wall unit 12 thus formed on the back glass substrate 5 partition the discharge space S2 between the front glass substrate 1 and the back glass substrate 5 into areas each corresponding to the opposing paired transparent electrodes Xa and Ya in each sustain electrode pair (X, Y), to form discharge cells C2.

The discharge space S2 between the front and back glass substrates 1 and 5 is filled with a discharge gas including xenon (Xe).

In the above-mentioned PDP 20, as in the case of conventional PDPs, are set discharge is produced between the sustain electrodes X and Y in the sustain electrode pairs (X, Y) or between the sustain electrode Y and the address electrode D1. Then, an address discharge is produced between the sustain electrode Y and the address electrode D1. Following that, a sustain discharge is produced across the discharge gap formed between the opposing transparent electrodes Xa and Ya of the sustain electrodes X and Y constituting the sustain electrode pair (X, Y). Thereby, an image is generated on matrix display.

In the PDP 20, the height (the width in the thickness direction of the PDP 20) of the discharge cell C2 is decided by the heights of the first partition wall unit 11 formed on the front glass substrate 1 and the second partition wall unit 12 formed on the back glass substrate 5 which are in contact with each other at their top faces, with the dielectric cover layer 21 in between.

The first partition wall unit 11 and the second partition wall unit 12 of the PDP 20 have the bases 11a and 12a formed of metal materials. Hence, as compared with the partition wall of a conventional PDP which is formed using glass materials and sandblasting technique, there is not possibility of a defect, an inclination and/or the like occurring in the partition wall units, and therefore the partition wall unit is capable of being formed to a required height.

Instead of an additional dielectric layer formed of dielectric materials, the PDP 20 has the metallic first partition wall unit 11 formed in the position corresponding to the additional dielectric layer formed in the conventional PDP. This makes it possible to design the greater height of the discharge cell C2 as compared with that of the conventional PDP.

Further, the first partition wall unit 11 has the function of preventing the spread of a surface discharge initiated between the sustain electrodes outward from the interior of the discharge cell C2, similar to that of the additional dielectric layer of the conventional PDP.

Thus, the PDP 20 is enabled to have the discharge cell C2 of a greater height than that of the conventional PDP. In turn, this makes it possible to improve the light-emitting efficiency even when the PDP is designed to have a higher definition.

Further, since the first partition wall unit 11 is formed on the front glass substrate 1, an increase in the height of the first partition wall unit 11 results in an increase in the area of the insulation film 11b which partially forms the first partition wall unit 11 and is made of a high γ material such as MgO. Therefore, the insulation layer 11b contributes to the improvement of the secondary electron emission characteristics in the discharge cell C2 as compared with the case of the conventional PDP. This improvement increases the discharge efficiency, resulting also in an increase in the light-emitting efficiency.

Further, if the height of the second partition wall unit 12 on the back glass substrate 5 is set high, the layer thickness and the surface area of the phosphor layer 28 formed on the inner surface of the second partition wall unit 12 can be increased, resulting also in an increase in the light-emitting efficiency.

In the PDP 20, by forming the address electrode D1 on the top face 11c of the first partition wall unit 11, the distance between the address electrode D1 and the transparent electrode Ya of the sustain electrode Y between which a discharge is caused (the discharge distance) is shorter than that in the PDP 10. This facilitates the initiation of a discharge between the address electrode D1 and the transparent electrode Ya of the sustain electrode Y. For this reason, the discharge voltage is reduced as compared with that in the PDP 10 and the address margin is widened.

In the PDP 20, the MgO layer (insulation film 11b) is formed only on the front glass substrate 1 and the phosphor layer 28 is formed only on the back glass substrate 5. For these reasons, the manufacturing steps for the front glass substrate 1 and the manufacturing steps for the back glass substrate 5 are performed independently, thus facilitating the entire manufacturing process.

The PDP 20 has the metallic first partition wall unit 11 formed on the front glass substrate 1 instead of the conventional additional dielectric layer. This design eliminates the need of the complicated steps for forming the additional dielectric layer. Further, because the previously formed first partition wall unit 11 is mounted on the rear-facing face of the dielectric layer 2, the manufacturing process is simplified.

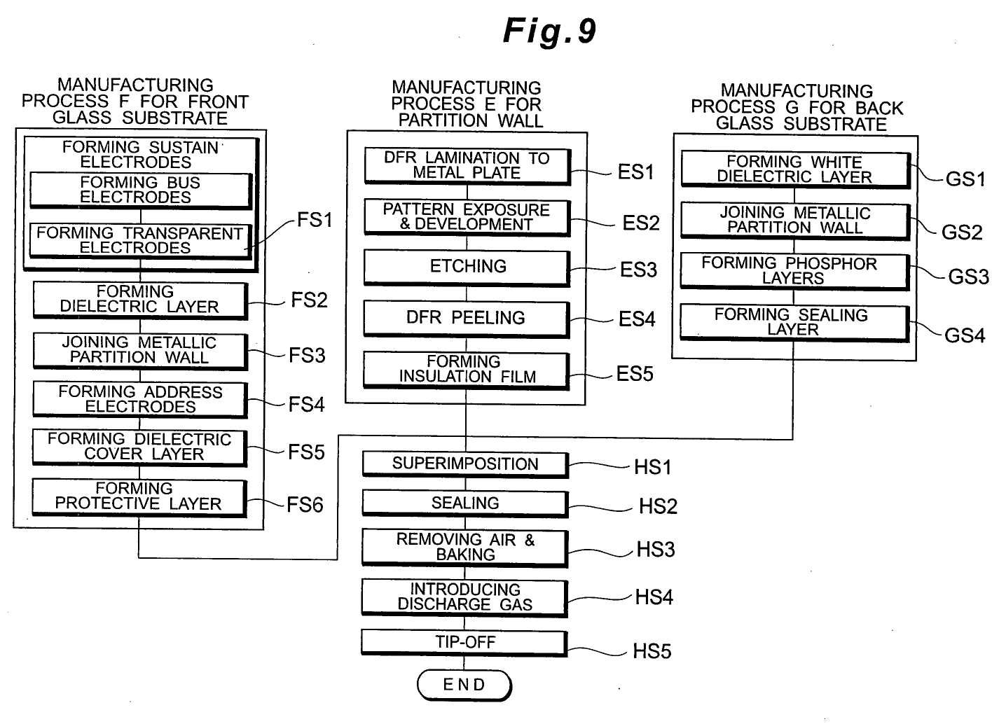

FIG. 9 shows a flowchart of the manufacturing process of the PDP 20.

Next, the manufacturing process for the PDP 20 will be described with reference to FIG. 9.

In the manufacturing process E for the metallic partition wall, the step for DFR lamination on a metal plate (step ES1) is performed, and then the step of pattern exposure and development (step ES2) is performed.

After step ES2, the step of etching (step ES3) is performed to form the metal plate into a substantial grid-shaped first partition wall unit 11 or a substantial grid-shaped second partition wall unit 12. Then, the step for DFR peeling (step ES4) is performed.

After step ES4, by a technique such as sputtering, evaporation or CVD, an insulation film 11b or 12b is formed on the surface of the metal plate which has been formed into the substantial grid shape in step ES4 (step ES5).

The manufacturing process E for the metallic partition wall is the same as the manufacturing process A for the metallic partition wall in the first embodiment.

In the manufacturing process F for the front glass substrate 1, sustain electrodes X and Y are first formed on the rear-facing face of the front glass substrate 1 (step FS1).

Step FS1 includes the step of forming the transparent electrodes Xa and Ya of the sustain electrodes X and Y and the step of forming the bus electrodes Xb and Yb thereof.

After the sustain electrode pairs (X, Y) have been formed in step FS1, a dielectric layer 2 is formed on the rear-facing face of the front glass substrate 1 (step FS2), so as to cover the sustain electrode pairs (X, Y) which have been formed in step FS1.

In step FS2, before the burning of the dielectric layer 2, the first partition wall unit 11 fabricated in the manufacturing process E is precisely positioned on the dielectric layer 2. By burning the dielectric layer 2, the first partition wall unit 11 is joined on to the dielectric layer 2 in a predetermined position (step FS3).

After step FS3, address electrodes D1 are formed on the top face 11c of the first partition wall unit 11 (step FS4). Then, a dielectric cover layer 21 is formed to cover the address electrodes D1 (step FS5).

After step FS5, a protective layer is formed on the rear-facing face of the dielectric layer 2 (step FS6).

In the manufacturing process G for the back glass substrate 5, a white dielectric layer 26 is first formed on the front-facing face of the back glass substrate 5 (step GS1).

In step GS1, before the burning of the white dielectric layer 26, the second partition wall unit 12 fabricated in the manufacturing process E for the metallic partition wall is precisely positioned on the white dielectric layer 26. By burning the white dielectric layer 26, the second partition wall unit 12 is joined onto the white dielectric layer 26 in a predetermined position (step GS2).

Then, after the completion of step GS2, red, green and blue phosphor layers 28 are each formed inside the areas defined by the grid-shaped second partition wall unit 12 (step GS3). Then, a sealing layer is formed on the periphery edge portion of the front-facing face of the back glass substrate 5 (step GS4).

The front glass substrate 1 with the various structures thus formed thereon in the manufacturing process F and the back glass substrate 5 with the various structures thus formed thereon in the manufacturing process G are placed on each other with precise alignment so as to form a discharge space between them (step HS1). Then, the step of sealing the discharge space between the front glass substrate 1 and the back glass substrate 5 (step HS2), the step of baking after removing the gases from the discharge space (step HS3), the step of introducing a discharge gas into the discharge space (step HS4), and the step of sealing the discharge gas inside (tip-off) (step HS5) are performed in order to fabricate a PDP 20.

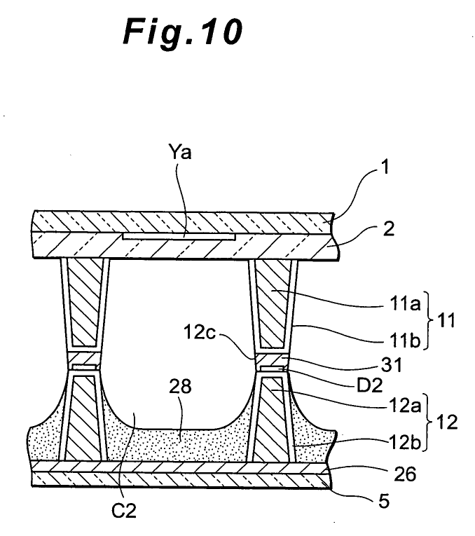

FIG. 10 is a sectional view illustrating a modified example of the PDP of the second embodiment described in FIGS. 7, 8A and 8B.

In the PDP in FIGS. 7, 8A and 8B, the column electrode D1 is formed on the first vertical wall 11A of the first partition wall unit 11 formed on the front glass substrate 1. In the PDP in FIG. 10, a column electrode D2 is formed on the second vertical wall 12A (see FIG. 7) of the second partition wall unit 12 formed on the back glass substrate 5, and is covered by a dielectric cover layer 31 that is formed on the top face 12c of the second partition wall unit 12.

The structure of the other components is approximately the same as that of the PDP in FIGS. 7 and 8A. The same components are designated by the same reference numerals as those in the PDP shown in FIGS. 7 and 8A.

The PDP in FIG. 10 is capable of exerting the same effects and advantages as those of the PDP described in FIG. 8A.

The terms and description used herein are set forth by way of illustration only and are not meant as limitations. Those skilled in the art will recognize that numerous variations are possible within the spirit and scope of the invention as defined in the following claims.

1. A plasma display panel having a pair of opposing first and second substrates with a discharge space in between, a plurality of row electrode pairs extending in a row direction and regularly arranged in a column direction on the first substrate, a dielectric layer formed on the first substrate and covering the row electrode pairs, and a plurality of column electrodes extending in the column direction and regularly arranged in the row direction for producing a discharge in conjunction with the row electrodes in each unit light-emitting area formed in the discharge space, the plasma display panel comprising:
a first partition wall unit that is provided on the first substrate for defining the unit light-emitting areas, and has a metal-made base formed in a required shape and an insulation film covering the surface of the base; and
a second partition wall unit that is provided on the second substrate for defining the unit light-emitting areas, is positioned opposite the first partition wall unit, and has a metal-made base formed in a required shape and an insulation film covering the surface of the base.

2. A plasma display panel according to claim 1, wherein the first partition wall unit and the second partition wall unit are in contact with each other and define the unit light-emitting areas.

3. A plasma display panel according to claim 1, wherein the insulation film of the first partition wall unit is formed of a secondary electron emission material.

4. A plasma display panel according to claim 3, wherein the secondary electron emission material is MgO.

5. A plasma display panel according to claim 1, further comprising phosphor layers respectively formed in areas defined by the second partition wall unit.

6. A plasma display panel according to claim 1, further comprising each of column electrodes formed on the first partition wall unit, and covered by a dielectric cover layer formed on the first partition wall unit.

7. A plasma display panel according to claim 6, wherein the first partition wall unit and the second partition wall unit are in contact with each other, with the dielectric cover layer in between.

8. A plasma display panel according to claim 1, further comprising each of column electrodes formed on the second partition wall unit and covered by a dielectric cover layer that is formed on the second partition wall unit.

9. A plasma display panel according to claim 8, wherein the first partition wall unit and the second partition wall unit are in contact with each other, with the dielectric cover layer in between.

10. A plasma display panel according to claim 6, wherein each of the row electrodes constituting each of the row electrode pairs has an electrode body extending in the row direction and a plurality of electrode projecting portions that are spaced at regular intervals along the electrode body and each extend out toward its counterpart row electrode in the row electrode pair to face the counterpart row electrode across a discharge gap, and wherein each of the column electrodes is placed in a plane following a line of intermediate areas between adjacent electrode projecting portions arranged along the electrode bodies of the row electrodes.

11. A plasma display panel according to claim 10, wherein each of the column electrodes is situated in a position which is between the adjacent electrode projecting portions arranged along the electrode bodies of the row electrodes and is closer to the electrode projecting portion initiating a discharge in conjunction with the column electrode.

12. A plasma display panel according to claim 1, wherein the first partition wall unit has transverse walls each extending in the row direction in an area between the adjacent unit light-emitting areas in the column direction.
